(19) United States
(12) Patent Application Publication
(10) Pub. No.: US 2026/0098233 A1
(43) Pub. Date: Apr. 9, 2026

(54) CLEANING SOLUTION FOR INKJET RECORDING APPARATUS AND INK SET

(71) Applicant: KYOCERA DOCUMENT SOLUTIONS INC., OSAKA (JP)

(72) Inventor: SHUNTA EHARA, OSAKA (JP)

(21) Appl. No.: 19/351,316

(22) Filed: Oct. 7, 2025

(30) Foreign Application Priority Data
Oct. 7, 2024 (JP) 2024-175975

(51) Int. Cl. C11D 3/37; C09D 11/322; C11D 1/82; C11D 1/90; C11D 3/43

(52) U.S. Cl. CPC C11D 3/3757; C09D 11/322; C11D 1/82; C11D 1/90; C11D 3/43; C11D 2111/22

(57) ABSTRACT

A cleaning solution is a cleaning solution for an inkjet recording apparatus, including: water, a surfactant, a water-soluble organic solvent, and a polyacrylic acid salt. The polyacrylic acid salt has a molecular weight of 30000 or more and 200000 or less. The content of the polyacrylic acid salt in the cleaning solution is 1.0 mass % or more and 20.0 mass % or less.

### CROSS-REFERENCE TO RELATED PATENT APPLICATION

This application claims the benefit of Japanese Priority Patent Application JP 2024-175975 filed Oct. 7, 2024, the entire contents of which are incorporated herein by reference.

### FIELD OF THE DISCLOSURE

The present disclosure relates to a cleaning solution for an inkjet recording apparatus and an ink set including the same.

### BACKGROUND OF THE DISCLOSURE

An inkjet recording apparatus forms an image on a recording medium by ejecting an ink for inkjet recording from an ejection surface of a recording head. A cleaning method is known in which a cleaning solution is supplied to the ejection surface and the ejection surface is wiped with a wiping blade to remove the stains caused by the ink remaining on the ejection surface (e.g., Japanese Patent Application Laid-open No. 2018-202746).

In the inkjet recording apparatus, stains are easily formed by the dried and fixed ink remaining on the ejection surface or the like, and the cleaning solution for an inkjet recording apparatus is desired to have high cleaning performance. As a cleaning aid for the fixed stains, a polyacrylic acid salt is known (see, for example, Japanese Patent Application Laid-open No. 2004-26989).

### SUMMARY OF THE DISCLOSURE

A cleaning solution according to an embodiment of the present disclosure is a cleaning solution for an inkjet recording apparatus, including:
water;
a surfactant;
a water-soluble organic solvent; and
a polyacrylic acid salt.

The polyacrylic acid salt has a molecular weight of 30000 or more and 200000 or less.

The content of the polyacrylic acid salt in the cleaning solution is 1.0 mass % or more and 20.0 mass % or less.

### DETAILED DESCRIPTION OF THE EXEMPLARY EMBODIMENTS

Meanwhile, in the case where a polyacrylic acid salt is added to a cleaning solution for an inkjet recording apparatus, there has been a risk that the dispersion stability of the pigment included in the ink is inhibited, leading to aggregates of the ink.

In view of the circumstances as described above, it is an object of the present disclosure to provide a cleaning solution that has high cleaning performance and is capable of suppressing the generation of ink aggregates when being mixed with the ink, and an ink set including the same.

An embodiment of the present disclosure will be described below. Note that In the following description, the expression “content of B in A” refers to the mass ratio of B when the mass of A is 100 mass %. Further, the components described in the present specification may each be used alone, or two or more of them may be used in combination.

### [Cleaning Solution for Inkjet Recording Apparatus]

The cleaning solution according to this embodiment is a cleaning solution for an inkjet recording apparatus. The cleaning solution is used to clean the ink remaining on the inkjet recording apparatus and the like, and may be, for example, a cleaning solution for cleaning the ejection surface of the recording head mounted on the inkjet recording apparatus onto which ink is ejected. In this embodiment, cleaning of the ejection surface includes removing ink stains adhered to the ejection surface and the like, and is, for example, supplying the cleaning solution to the ejection surface and wiping the ejection surface with a wiping member such as a blade. Alternatively, the cleaning solution can be used to clean not only the ejection surface but also the blade used in the wipe operation, the conveying roller, and the like.

The cleaning solution according to this embodiment includes water, a surfactant, a water-soluble organic solvent, and a polyacrylic acid salt.

### (Water)

The content of water in the cleaning solution according to this embodiment is appropriately set in accordance with the contents of other components, and is favorably 40.0 mass % or more and 95.0 mass % or less, more favorably 60.0 mass % or more and 90.0 mass % or less.

### (Surfactant)

The cleaning solution according to this embodiment includes one or two or more types of surfactants that can be used in the present technical field. Examples of the surfactant include a cationic surfactant, an anionic surfactant, an amphoteric surfactant, and a nonionic surfactant. Of these, favorably at least one selected from the group consisting of an amphoteric surfactant and a nonionic surfactant, more favorably an amphoteric surfactant having a betaine structure and/or a silicone surfactant, still more favorably an amphoteric surfactant having a betaine structure, is included as a surfactant in the cleaning solution according to this embodiment.

### (Amphoteric Surfactant Having Betaine Structure)

The amphoteric surfactant having a betaine structure has excellent performance in adhering to the surroundings of stains (a pigment, a resin component, and the like) fixed to a cleaning target (e.g., the above ejection surface) to release the stains from the cleaning target and excellent performance in dispersing the released stains in the cleaning solution. Note that the betaine refers to an intramolecular salt having a cationic structure (e.g., a quaternary ammonium ion structure) and an anionic structure (e.g., an anionic structure of an acid such as carboxylic acid) in one molecule. As the amphoteric surfactant having a betaine structure, an amphoteric surfactant having an amidoalkyl betaine structure is favorable. As the amphoteric surfactant having an amidoalkyl betaine structure, a compound represented by the following general formula (1) is favorable.

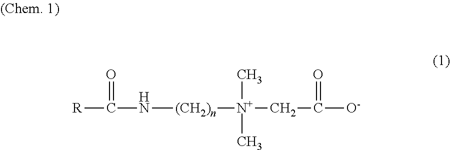

In the general formula (1), R represents a monovalent chain hydrocarbon group having 6 or more and 20 or less carbon atoms. n represents an integer of 1 or more and 5 or less.

R favorably represents a monovalent chain hydrocarbon group having 10 or more and 18 or less carbon atoms. Examples of the monovalent chain hydrocarbon group represented by R include a chain alkyl group and a chain alkenyl group. n favorably represents 3.

Examples of the amphoteric surfactant having an amidoalkyl betaine structure include a fatty acid amidopropyl betaine surfactant. Examples of the fatty acid amidopropyl betaine surfactant include coconut oil fatty acid amidopropyl betaine, lauramidopropyl betaine, palm kernel fatty acid amidopropyl betaine, isostearic acid amidopropyl betaine, and linoleic acid amidopropyl betaine. As the amphoteric surfactant having an amidoalkyl betaine structure, coconut oil fatty acid amidopropyl betaine, lauramidopropyl betaine, or palm kernel fatty acid amidopropyl betaine is favorable.

The content of the amphoteric surfactant having a betaine structure in the cleaning solution is favorably 0.01 mass % or more and 2.0 mass % or less, more favorably 0.05 mass % or more and 1.0 mass % or less, from the viewpoint of imparting excellent cleaning performance to the cleaning solution.

### (Silicone Surfactant)

The silicone surfactant reduces the surface tension of the cleaning solution, making the cleaning solution easier to penetrate into stains. The silicone surfactant means a surfactant having a siloxane bond. As the silicone surfactant, a polyether-modified silicone surfactant is favorable and a polyether-modified polydimethylsiloxane is more favorable.

In the cleaning solution, the content of the silicone surfactant is favorably 0.05 mass % or more and 2.0 mass % or less, more favorably 0.1 mass % or more and 1.0 mass % or less, from the viewpoint of imparting appropriate surface tension to the cleaning solution.

In the cleaning solution, the total content of the amphoteric surfactant having a betaine structure and the silicone surfactant is favorably 0.1 mass % or more and 5.0 mass % or less, mor favorably 0.2 mass % or more and 3.0 mass % or less.

### (Water-Soluble Organic Solvent)

The cleaning solution according to this embodiment includes one or two or more types of water-soluble organic solvents from the viewpoint of enhancing miscibility with water to impart favorable physical properties (viscosity, surface tension, etc.) to the cleaning solution. Examples of the water-soluble organic solvent include a polyhydric alcohol, glycol ether, a lactam compound, a nitrogen-containing compound, an acetate compound, thiodiglycol, and dimethylsulfoxide. Note that the water-soluble organic solvent in the present disclosure refers to an organic solvent having solubility in water of 1.0 mass % or more at 25° C.

Examples of the polyhydric alcohol include a glycol compound and glycerin. Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and polyethylene glycol.

Examples of glycol ether include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethyl ether acetate.

The lower limit of the total content of the water-soluble organic solvent in the cleaning solution is favorably 3.0 mass % or more, more favorably 5.0 mass % or more, from the viewpoint of imparting appropriate physical properties (viscosity, surface tension, etc.) to the cleaning solution. Further, the upper limit of the total content of the water-soluble organic solvent is favorably 40.0 mass % or less, more favorably 35.0 mass % or less, considering the balance with other raw materials.

Further, the SP value of the water-soluble organic solvent according to this embodiment favorably exceeds 24 MPa^{1/2}, more favorably is 26 MPa^{1/2} or more. The SP value (solubility parameter/unit: MPa^{1/2}) of the water-soluble organic solvent is a value represented by the square root of the molecular cohesive energy, and can be calculated by the method described in R. F. Fedors, Polymer Engineering Science, 14, p 147 to 154 (1974). Note that in the case where the cleaning solution includes two or more types of water-soluble organic solvents, each of the two or more types of water-soluble organic solvents favorably has an SP value of exceeding 24 MPa^{1/2}.

The water-soluble organic solvent having an SP value of 24 MPa^{1/2} or less enhances the swellability of the fixed ink to contribute to cleaning performance. Meanwhile, according to the present inventors, such a solvent poses a risk of accelerating the deterioration of the members of the recording head that ejects the ink for an inkjet recording apparatus. By including the polyacrylic acid salt described below, the cleaning solution according to this embodiment is capable of improving the cleaning performance and reducing the risk of the deterioration of members without including the water-soluble organic solvent having an SP value of 24 MPa^{1/2} or less.

Examples of the water-soluble organic solvent having an SP value of exceeding 24 MPa^{1/2} include a polyhydric alcohol. Specific examples thereof include ethylene glycol (30.34), diethylene glycol (30.62), triethylene glycol (27.79), propylene glycol (27.59), dipropylene glycol (27.14), 1,2-butanediol (26.09), 2-methyl-1,3-butanediol (28.27), 1,2-pentanediol (28.64), 1,5-pentanediol (28.96), 1,6-hexanediol (27.66), glycerin (33.52), dimethylsulfoxide (26.92), dimethylformamide (30.62), methanol (28.17), isopropyl alcohol (28.69), and triethanolamine (32.27). Note that the numerical values in parentheses after the specific examples are SP values (unit: MPa^{1/2}).

### (Polyacrylic Acid Salt)

The cleaning solution according to this embodiment includes a polyacrylic acid salt. As the polyacrylic acid salt, an alkali metal salt such as a sodium salt and a potassium salt is favorable, and sodium polyacrylate is particularly favorable from the viewpoint of improving the cleaning performance described below.

In this embodiment, the polyacrylic acid salt has a molecular weight of 30000 or more and 200000 or less, favorably 50000 or more and 170000 or less. The polyacrylic acid salt having such a molecular weight allows it to be easily adsorbed on the fixed ink stains by the electrostatic effect or the like to easily disperse the ink stains in the cleaning solution, thereby enhancing the cleaning performance of the cleaning solution. Further, the polyacrylic acid salt has a low risk of deteriorating the members of the recording head of the inkjet recording apparatus and is capable of enhancing cleaning performance while protecting the recording head. Note that in the present specification, the molecular weight of the polyacrylic acid salt is a weight average molecular weight (Mw) and is a value measured using gel permeation chromatography.

Further, by setting the molecular weight of the polyacrylic acid salt to 30000 or more and 200000 or less, it is possible to limit the content of the polyacrylic acid salt while achieving the effect of improving cleaning performance. Specifically, the content of the polyacrylic acid salt in the cleaning solution according to this embodiment is 1.0 mass % or more and 20.0 mass % or less, favorably 1.2 mass % or more and 15 mass % or less. If the content of the polyacrylic acid salt exceeds 20.0 mass %, when the cleaning solution is mixed with the ink, the electrostatic effect of the excessive polyacrylic acid salt disrupts the dispersibility of the pigment to increase the risk of promoting the ink agglomeration. Meanwhile, by setting the content of the polyacrylic acid salt to 20.0 mass % or less, it is possible to suppress the ink agglomeration when the cleaning solution is mixed with the ink. Further, by setting the content of the polyacrylic acid salt in the cleaning solution to 1.0 mass % or more, it is possible to achieve the above-mentioned effect of enhancing cleaning performance.

### (Other Components)

The cleaning solution may further include known additives (e.g., a dissolution stabilizer, an anti-drying agent, an antioxidant, a viscosity adjustor, a pH adjuster, and an antifungal agent) as necessary.

(Summary of this Embodiment)

As described above, according to the cleaning solution according to this embodiment, by including 1.0 mass % or more and 20.0 mass % or less of the polyacrylic acid salt having a molecular weight of 30000 or more and 200000 or less, it is possible to enhance the cleaning performance against the fixed ink stains while reducing the risk of deteriorating the members of the recording head of the inkjet recording apparatus. Further, by setting the molecular weight of the polyacrylic acid salt to 30000 or more and 200000 or less, the content of the polyacrylic acid salt can be 1.0 mass % or more and 20.0 mass % or less, and it is possible to suppress the ink agglomeration in the cleaning solution due to the excessive polyacrylic acid salt. As a result, it is possible to suppress the nozzle ejection failure due to the agglomerated ink and suppress defects such as ink misdirection due to the ejection failure.

### [Ink Set for Inkjet Recording Apparatus]

The present disclosure provides an ink set for an inkjet recording apparatus as another embodiment. The ink set according to this embodiment includes the abovementioned cleaning solution and an ink. Since the cleaning solution may have the same configuration as that in the above-mentioned embodiment, the detailed description thereof is omitted.

### (Ink)

The ink according to this embodiment has dry viscosity at 25° C. of the ink dried by 50 mass % of 516 mPa's or more. The phrase “ink dried by 50 mass %” refers to when the ink is placed in a container such as a petri dish, dried in a constant temperature bath at, for example, 60° C., and the mass of the ink reaches 50 mass % with respect to the mass of the ink before drying being 100 mass %. The dry viscosity refers to a value measured at 25° C. using a dried ink and a falling-ball automatic microviscometer (e.g., “AMVn” manufactured by Anton Paar GmbH) in accordance with the method described in Japanese Industrial Standard (JIS) Z8803:2011 “Methods for viscosity measurement of liquid”.

The ink having the above dry viscosity generally includes an aqueous solvent and a pigment particle and has a configuration in which a plurality of pigment particles is dispersed in the aqueous solvent. The pigment particle generally includes a pigment core containing a pigment and a coating resin provided on the surface of the pigment core.

In many cases, a resin salt is used as a coating resin. Here, the resin salt has an ionizable functional group (e.g., COONa group) in its molecule. Further, the aqueous ink includes a sufficient amount of aqueous solvent. For these reasons, ionization is likely to occur on the surface of the coating resin. For this reason, an electric double layer can be formed on the surface of the coating resin. When an electric double layer is formed on the surface of the coating resin, the pigment particles repel each other, causing the pigment particles to disperse.

Meanwhile, in the case where the above ink remains on the ejection surface or the like and is dried until reaching 50 mass %, the content ratio of the aqueous solvent in the ink decreases and the content ratio of the pigment particle increases. On the surface of the coating resin of such a pigment particle, ionization is difficult to occur. As a result, the pigment particles become difficult to repel each other, making the pigment particles more likely to agglomerate.

On the other hand, the above cleaning solution is capable of being adsorbed on the surface of the fixed coating resin by the electrostatic effect or the like of the polyacrylic acid salt, and dispersing the pigment particle in the cleaning solution. Further, by setting the molecular weight of the polyacrylic acid salt to 30000 or more and 200000 or less and the content of the polyacrylic acid salt in the cleaning solution to 1.0 mass % or more and 20.0 mass % or less, it is possible to maintain the electrostatic repulsion of the dispersed pigment particles to suppress the agglomeration of the pigment particles without disrupting the balance of the electrostatic effect in the cleaning solution. Therefore, the ink set according to this embodiment is also capable of suppressing the nozzle ejection failure due to the agglomerated ink and defects such as ink misdirection due to the ejection failure.

Although an embodiment of the present disclosure has been described above, the present disclosure is not limited to only the above-mentioned embodiment, and various modifications can be made without departing from the essence of the present disclosure.

### Examples

Although Examples of the present disclosure will be described, the present disclosure is not limited to the following Examples. Further, “parts” indicates “parts by mass”.

### [Preparation of Cleaning Solution]

Cleaning solutions (CLN-1) to (CLN-4) were prepared by the following method. Note that the cleaning solutions (CLN-1) and (CLN-4) were used as cleaning solution samples according to Comparative Examples of the present disclosure, and the cleaning solutions (CLN-2) and (CLN-3) were used as cleaning solution samples according to Examples of the present disclosure.

### (Cleaning Solution (CLN-1))

10 parts of 1,3-propanediol (manufactured by MARUZEN GROUP), 0.1 part of AMOGEN (registered trademark) CB-H (manufactured by DKS Co. Ltd.), 0.14 parts of SAG002 (manufactured by Nissin Chemical Co., Ltd.), 35 parts of sodium polyacrylate (DL40 (manufactured by NIPPON SHOKUBAI CO., LTD.)), and 54.76 parts (remainder) of ion exchanged water were added to a container and stirred to prepare a cleaning solution (CLN-1). Of the above raw materials, 1,3-propanediol is classified as a water-soluble organic solvent. AMOGEN CB-H is classified as an amidobetaine type amphoteric surfactant. SAG002 is classified as a silicone surfactant. DL40 that is sodium polyacrylate had a weight average molecular weight (Mw) of 3000.

### (Cleaning Solution (CLN-2))

A cleaning solution (CLN-2) was prepared in the same manner as that for the cleaning solution (CLN-1) except that sodium polyacrylate was replaced with 10 parts of DL452 (manufactured by NIPPON SHOKUBAI CO., LTD.) and the parts of ion exchanged water was changed to 79.76 parts (remainder). DL452 that is sodium polyacrylate had a weight average molecular weight (Mw) of 50000.

### (Cleaning Solution (CLN-3))

A cleaning solution (CLN-3) was prepared in the same manner as that for the cleaning solution (CLN-1) except that sodium polyacrylate was replaced with 1.5 parts of DL522 (manufactured by NIPPON SHOKUBAI CO., LTD.) and the parts of ion exchanged water was changed to 88.26 parts (remainder). DL522 that is sodium polyacrylate had a weight average molecular weight (Mw) of 170000.

### (Cleaning Solution (CLN-4))

A cleaning solution (CLN-4) was prepared in the same manner as that for the cleaning solution (CLN-1) except that sodium polyacrylate was replaced with 1.5 parts of an ammonium polyacrylate solution 70-110 (manufactured by FUJIFILM Wako Pure Chemical Corporation) and the parts of ion exchanged water was changed to 79.96 parts (remainder). The ammonium polyacrylate solution 70-110 had a weight average molecular weight (Mw) of 10000.

TABLE 1

| | | Comparative | | | Comparative |
|---|---|---|---|---|---|
| | | Example | Example | Example | Example |
| | | CLN-1 | CLN-2 | CLN-3 | CLN-4 |
| Organic solvent [parts by mass] | 1,3-propanediol | 10.0 | 10.0 | 10.0 | 10.0 |
| Surfactant | AMOGEN CB-H | 0.1 | 0.1 | 0.1 | 0.1 |
| [parts by mass] | SAG002 | 0.14 | 0.14 | 0.14 | 0.14 |
| Polyacrylic acid salt | DL40 | 35 | — | — | — |
| [parts by mass] | DL452 | — | 10 | — | — |
| | DL522 | — | — | 1.5 | — |
| | Ammonium polyacrylate | — | — | — | 10 |
| | solution 70-110 | | | | |

| | | | | |
|---|---|---|---|---|
| Ion exchanged water | Remainder | Remainder | Remainder | Remainder |
| Total [parts by mass] | 100.0 | 100.0 | 100.0 | 100.0 |

### [Evaluation of Cleaning Performance]

The plate including the ink ejection surface was removed from a recording head (“KJ4B-1200” manufactured by KYOCERA Corporation). This plate was used as an evaluation plate. The above-mentioned ink was ejected onto the ink ejection surface of the evaluation plate using another recording head (“KJ4B-1200” manufactured by KYOCERA Corporation) to form a grid-like dot pattern (1000 dots). The ink was an ink that included a pigment particle, water, a resin (such as an acrylic resin and a urethane resin), a water-soluble organic solvent (such as propylene glycol), and a surfactant, and had dry viscosity at 25° C. of the ink dried by 50 mass % of 516 mPa's or more. In the formation of the dot pattern, the volume of ink per drop was set to 15 pL (one dot was formed with 15 pL of ink). Next, the evaluation plate was dried at 60° C. for 1 hours. The evaluation plate is a sample that simulates the condition in which the dried ink has adhered to the ink ejection surface of the recording head as stains.

0.1 mL of each of the prepared cleaning solutions was supplied to the above-mentioned evaluation plate (supply amount per unit area: 2.5 μL/cm²). Next, the evaluation plate was wiped (line pressure of 10 N/m) at a wiping speed of 20 mm/sec using a rubber wiping blade. Subsequently, after supplying 0.1 mL of each cleaning solution, the evaluation plate was wiped (line pressure of 10 N/m) at 20 mm/sec using the above-mentioned wiping blade, similarly.

After the two times of wiping, the ink ejection surface of the evaluation plate was observed and the number of remaining dots was counted. The removal ratio of dots (100×{1000−the number of remaining dots}/1000) was calculated and the cleaning performance was evaluated on the basis of the following evaluation criteria. The results are shown in Table 2.

### (Cleaning Performance Criteria)

A (Good): the removal ratio is 90.0% or more.
B (Poor): the removal ratio is 70.0% or more and less than 90.0%.
C (Particularly poor): the removal ratio is less than 70.0%.

TABLE 2

| | | Comparative | | | Comparative |
|---|---|---|---|---|---|
| | | Example | Example | Example | Example |
| | | CLN-1 | CLN-2 | CLN-3 | CLN-4 |
| Molecular weight (Mw) of polyacrylic acid salt | | 3000 | 50000 | 170000 | 10000 |
| Content (mass %) of polyacrylic acid salt | | 35 | 10 | 1.5 | 10 |
| Cleaning performance | Removal ratio (%) | 64 | 92 | 91 | 70 |
| | Determination | C | A | A | B |
| Ink agglomeration | Number of coarse particles | 1166 | 348 | 337 | 1085 |
| | Determination | C | A | A | C |

As shown in Table 2, the cleaning solutions (CLN-2) and (CLN-3) that have a molecular weight of 30000 or more and 200000 or less and include 1.0 mass % or more and 20.0 mass % or less of a polyacrylic acid salt had a removal ratio of dots of 90.0% or more and cleaning performance evaluated as A. On the other hand, the cleaning solution (CLN-1) that has a molecular weight of 3000 and includes 35 mass % of a polyacrylic acid salt had cleaning performance evaluated as C. Further, the cleaning solution (CLN-4) that has a molecular weight of 10000 and includes 10 mass % of a polyacrylic acid salt had cleaning performance evaluated as B. From these results, it was found that a cleaning solution that has a molecular weight of 30000 or more and 200000 or less and includes 1.0 mass % or more and 20.0 mass % or less of a polyacrylic acid salt had high cleaning performance.

### [Evaluation of Ink Agglomeration]

An ink similar to that in the above-mentioned “Evaluation of cleaning performance” was prepared. The ink and each cleaning solution was mixed at a ratio of 1:1. After that, the mixed solution was diluted 100 times, and the number of coarse particles (0.5 μm or more, less than 200 μm) was measured using a flow-type particle image analyzer (FPIA-300, manufactured by Sysmex Corporation). The results are shown in Table 2.

### (Agglomeration Criteria)

A (Good): the number of agglomerated particles is less than 500.
B (Poor): the number of agglomerated particles is 500 or more and less than 1000.
C (Particularly poor): the number of agglomerated particles is 1000 or more.

As shown in Table 2, the cleaning solutions (CLN-2) and (CLN-3) that have a molecular weight of 30000 or more and 200000 or less and include 1.0 mass % or more and 20.0 mass % or less of a polyacrylic acid salt had ink agglomeration evaluated as A. On the other hand, the cleaning solution (CLN-1) that has a molecular weight of 3000 and includes 35 mass % of a polyacrylic acid salt and the cleaning solution (CLN-4) that has a molecular weight of 10000 and includes 10 mass % of a polyacrylic acid salt had ink agglomeration of evaluated as C. From these results, it was found that a cleaning solution that has a molecular weight of 30000 or more and 200000 or less and includes 1.0 mass % or more and 20.0 mass % or less of a polyacrylic acid salt was capable of sufficiently suppressing the ink agglomeration.

It should be understood by those skilled in the art that various modifications, combinations, sub-combinations and alterations may occur depending on design requirements and other factors insofar as they are within the scope of the appended claims or the equivalents thereof.

What is claimed is:

1. A cleaning solution for an inkjet recording apparatus, comprising:
water;
a surfactant;
a water-soluble organic solvent; and
a polyacrylic acid salt,
the polyacrylic acid salt having a molecular weight of 30000 or more and 200000 or less,
a content of the polyacrylic acid salt in the cleaning solution being 1.0 mass % or more and 20.0 mass % or less.

2. The cleaning solution according to claim 1, wherein
the polyacrylic acid salt includes sodium polyacrylate.

3. The cleaning solution according to claim 1, wherein
the water-soluble organic solvent has an SP value of exceeding 24 MPa^{1/2}.

4. The cleaning solution according to claim 1, wherein
the surfactant includes a surfactant having a betaine structure.

5. An ink set for an inkjet recording apparatus, comprising:
the cleaning solution according to claim 1; and
an ink,
dry viscosity at 25° C. of the ink dried by 50 mass % being 516 mPa's or more.
